(19) United States
(12) Patent Application Publication
(10) Pub. No.: US 2010/0208757 A1
(43) Pub. Date: Aug. 19, 2010

(54) METHOD OF FERROELECTRONIC DOMAIN INVERSION AND ITS APPLICATIONS

(76) Inventor: Ye Hu, Dundas (CA)

Correspondence Address: Russ Weinzimmer, 614 Nashua Street, Suite 53, Milford, NH, 03055, US

(21) Appl. No.: 12/670,765

(22) PCT Filed: Jul. 31, 2008
(86) PCT No.: PCT/CA2008/001390

§ 371 Date: Jan. 26, 2010

Related U.S. Application Data
(60) Provisional application No. 60/952,969, filed on Jul. 31, 2007.

(51) Int. Cl. H01S 3/109; H05F 3/00

(52) U.S. Cl. 372/22; 204/164

(57) ABSTRACT

The present invention is related to a method to control the nucleation and to achieve designed domain inversion in single-domain ferroelectric substrates (e.g. MgO doped LiNbO₃ substrates). It includes the first poling of the substrate with defined electrode patterns based on the corona discharge method to form shallow domain inversion (i.e. nucleation) under the electrode patterns, and is followed by the second crystal poling based on the electrostatic method to realize deep uniform domain inversion. Another objective of the present invention is to provide methods to achieve broadband light sources using a nonlinear crystal with a periodically domain inverted structure.

### CROSS-REFERENCES TO RELATED APPLICATIONS

This application is entitled to the benefit of International Application Number PCT/US2008/001390 entitled “METHOD OF FERROELECTRONIC DOMAIN INVERSION AND ITS APPLICTIONS” filed Jul. 31, 2008.

### BACKGROUND OF THE INVENTION

1. Field of the Invention

The present invention relates to forming a domain inversion structure in a ferroelectric substrate and its application in broadband light generation based on the quasiphase matching (QPM) technique.

2. Description of the Related Art

In the development of the QPM based optical nonlinear devices such as wavelength converters, precise control of domain inversion of ferroelectric materials is necessary. One example of the wavelength converters is disclosed in a literature “J. A. Armstrong et al., Physical Review, vol. 127, No. 6, Sep. 15, 1962, pp. 1918-1939”. In this literature, the wavelength conversion device employs a wavelength conversion element in which a periodical domain inversion grating is formed along the grating direction so as to satisfy the QPM condition. By inputting fundamental light of an angular frequency of co into the wavelength conversion element, the wavelength conversion is achieved so as to obtain converted light of an angular frequency 2ω, i.e., second-harmonic generation (SHG). The period of the domain inversion grating Λ is decided by the QPM condition (i.e. 2ω(n_{2ω}−n_{ω})=2πc/Λ, where n_{2ω} and n_{ω} are refractive indices at 2ω and ω, respectively, c is light velocity in vacuum). Instead, if a pump light with an angular frequency of 2ω is launched into the same device, a signal and an idle light at angular frequency ωₛ and ωᵢ, respectively, are generated (where 2ω=ωₛ+ωᵢ) through the spontaneous parametric down conversion (SPDC) process. In the SPDC process, a similar QPM condition has to be satisfied, i.e. 2ωn_{2ω}−ωₛnₛ−ωᵢnᵢ=2πc/Λ, where n_{2ω}, nₛ and nᵢ are refractive indices at 2ω, ωₛ and ωᵢ, respectively, c is light velocity in vacuum. Since a number of pairs of ωₛ and ωᵢ can satisfy the QPM condition for a fixed period, the generated SPDC light usually has a broad bandwidth around an angular frequency of ω.

To achieve efficient wavelength conversions, high uniform periodically domain inverted structure through out the thickness of the crystal is required. To achieve wavelength converters with high efficiency and large output power, a substrate with high optical damage threshold (such as MgO doped lithium niobate) has to be employed. Due to the nature of non-perfect doping, however, special attention has to be paid in poling the doped substrates.

One method to form the periodically domain inverted structure in doped ferroelectric materials (e.g. MgO doped lithium niobate) is based on the corona discharge technique, which is disclosed in literatures “C. Q. Xu, et al., U.S. provisional Patent No. 60/847122; Akinori Harada, U.S. Pat. No. 5,594,746; Akinori Harada, U.S. Pat. No. 5,568,308; A. Harada, et al., Applied Physics Letters, vol. 69, no. 18, 1996, pp. 2629-2631”, as shown in FIG. 1 In these literatures, a corona wire or touch 3 is set on top of −c surface of a MgO doped lithium niobate single crystal substrate 1 with a periodical electrode pattern 2 on +c surface of the substrate. The electrode is made of metal and grounded. If the corona wire is supplied with a high voltage provided by a high voltage source 5, corona discharge happens, resulting negative charges on −c surface of the substrate. Due to the existence of the charges on −c surface, a voltage potential difference is created, generating a strong electric field across the substrate. If the generated electric field is larger than the internal electric field (i.e. coerceive field) of the crystal, domain under the electrode is inverted since the direction of the generated electric field is opposite with the internal field of the crystal. Since the coerceive field decreases with the increase of temperature, a temperature controller 6 may be employed to reduce the electric field required for domain inversion.

It is well known that the corona discharge method can overcome the non-uniform doping problem since migration of the surface charges deposited by the corona discharge is very slow. As a result, crystal poling takes place as far as the local coercive field is achieved. While uniform domain inversion can be achieved by employing the corona discharge technique, the shape of the inverted domain is not good. In other words, the inverted domain usually does not go through the crystal vertically along the thickness direction of the substrate, which causes problem if the developed domain inverted crystal is used in a form of bulk.

Another method to form the periodically domain inverted structure in MgO doped lithium niobate is based on the electrostatic technique, which is disclosed in literatures “M. Yamada, et al., U.S. Pat. No. 5,193,023; M. Yamada, et al., Applied Physics Letters, vol. 62, no. 5, 1993, pp. 435-436; J. Webjorn , et al., U.S. Pat. No. 5,875,053; Byer, et al., U.S. Pat. No. 5,714,198, U.S. Pat. No. 5,800,767, U.S. Pat. No. 5,838,702”, as shown in FIG. 1(b) and (c). In these literatures, an electrode pattern 2 is formed on +c surface of an MgO doped lithium niobate single crystal substrate 1. The electrode pattern 2 can either be metal (FIG. 1(b)) or isolator such as photoresist (FIG. 1(c)). A strong electric field is applied across the substrate by a high voltage source 5. If the applied electric field is larger than the internal electric field (i.e. coerceive field) of the crystal, domain under the electrode (FIG. 1(b)) or the opening of the isolator pattern (FIG. 1(c)) is inverted since the direction of the applied electric field is opposite with the internal field of the crystal. High voltage is applied between electrodes 2 and 4 in FIG. 1(b) or 3 and 4 in FIG. 1(c). Since the coerceive field decreases with the increase of temperature, a temperature controller 6 may be employed to reduce the electric field required for domain inversion.

While the electrostatic technique is successful in poling non-doped crystals with vertical domain shapes, it is difficult to achieve uniform poling due to the non-uniform doping. The nucleation of the domain inversion forms randomly on the surface of the substrate. As a result, distribution of the electric field applied across the substrate is changed when crystal poling starts and thus causes non-uniform poling.

One method to solve the problem is to reduce the required electric field for crystal poling, which is disclosed in literatures M. Nakamura, et al., Jpn. J. Appl. Phys., vol. 38, 1999, pp. L1234-1236; H. Ishizuki, et al., Appl. Phys. Lett., vol. 82, No.23, 2003, pp. 4062-4065; K. Nakamura, et al., J. Appl. Phys., vol. 91, No. 7, 2002, pp. 4528-4534. The required electric field can be reduced by increasing poling temperature up to 170 C and/or reducing thickness of the substrate down to 300 um. Although these methods have some effect on achieving uniform poling of large period (>20 μm), it is difficult to achieving uniform poling of short period (<10 μm). In addition, increasing temperature causes difficulty in fabrication process and reducing substrate thickness limits applications of the developed crystals.

Another method to solve the problem is to use thick substrate and short pulse electric field in poling, which is disclosed in literatures K. Mizuuchi, et al., U.S. Pat. No. 6,353,495; K. Mizuuchi, et al., J. Appl. Phys., vol. 96, No. 11, 2004, pp. 6585-6590. In this method, due to the use of thick substrate (e.g. 1 mm thick) and short pulse poling voltage, the inverted domains do not go through the whole substrate. As a result, even through poling starts randomly due to non-uniform doping, the electric filed distribution is not changed even though poling starts at certain locations since the inverted domains do not go through the substrate and thus poling current is significantly suppressed. However, in this method, about half of the crystal is wasted since the domain inversion structure is degraded gradually and finally disappears from +c surface to −c surface of the substrate.

The other method to solve the problem is to use a thermal treatment process followed by electrostatic poling, which is disclosed in literature, Peng , et al. , U.S. Pat. No. 6,926,770. In this method, a uniform nucleation layer determined by the first metal electrode is achieved by a thermal treatment process at high temperature (e.g. 1050° C.). The heat treating of the first metal electrode and nonlinear crystal in ambient oxygen at lower than Curie temperature causes a shallow surface domain inversion, which can be realized by Li out-diffusion in heat treatment, or Ti-ion in-diffusion in heat treatment. After the thermal treatment, the second electrode pattern is formed, and pulsed voltage (higher than the coercive voltage of the crystal) is applied across the crystal to achieve deep domain inversion. However, due to the need of high temperature treatment and the formation of the second electrode, the whole process is complex, throughput of the product is low, and thus production cost is high according to this method. Instead of forming nucleation, proton exchange outside the regions of metal electrode is used to prevent nucleation in regions without covering of masks such as metal electrode patterns, which is disclosed in a literature: S. Grilli, et al., Applied Physics Letters, vol. 89, No.3, 2006, pp. 2902-2905. However, this method cannot guarantee formation of uniform nucleation underneath the metal electrode, and thus deep uniform domain inversion over large area has not been achieved by this method.

The developed periodically poled crystals can be used as nonlinear media required in the spontaneous parametric down conversion (SPDC) process. SPDC is a well known optical nonlinear process, which is disclosed in many literatures such as M. Fiorentino, et al., Optics Express, Vol. 15, Issue 12, pp. 7479-7488; L. E. Myers, et al., J. Opt. Soc. Am. B, vol. 12, No. 11, 1995, pp. 2102-2116. In the SPDC process, a pump light with an angular frequency of ωₚ is launched into a nonlinear crystal, a signal and an idle light at angular frequency ωₛ and ωᵢ, respectively, is generated. Typically, the pump beam passes through the nonlinear crystal for only one time and the generated SPDC light power is low. To enhance the efficiency of PDC, the crystal is put into an optical cavity, with high reflection at both ωₛ and ωᵢ (double resonant), or ωₛ or ωᵢ (single resonant). Although the output power of the PDC light can be enhanced by using the double or single resonant structure, the bandwidth of the PDC light is significantly reduced. For optical sensing and optical coherence tomography (OCT) applications, light sources with a broad bandwidth of spectrum and high output power are required.

### 3. SUMMARY OF THE INVENTION

The objective of the present invention is to provide a domain inversion method, which is especially effective in poling doped crystals. In this method, the first poling of the substrate with defined electrode patterns is first conducted using the corona discharge method to form uniform shallow domain inversions (i.e. nucleation) under the metal electrode patterns, and then the second deep poling is conducted based on the electrostatic method to realize deep domain inversion. Another objective of the present invention is to provide methods to achieve broadband light sources using a nonlinear crystal with a domain inverted structure.

According to one aspect of the present invention, as shown in FIG. 2, a nonlinear crystal 1 with a domain-inverted structure is placed in an optical cavity. Facets of the nonlinear crystal is coated with films 2 and 3, which have high transmission around wavelength λ_{f} (broad bandwidth) and high reflection at half wavelength of λ_{f}. The cavity is formed by a rear mirror 4 and a front mirror 5. The rear mirror 4 has high reflection at around λ_{f} (broad band), while the front mirror 5 has high reflection at λ_{f} (narrow band). A laser crystal 6 is included in the cavity to generate the lasing wavelength λ_{f}. The facets of the laser crystal are coated, with films 7 and 8, which have high transmission at λ_{f}. A pump laser diode 9 emitting high power at λₚ is used to pump the laser crystal 6.

### 4. BRIEF DESCRIPTION OF THE DRAWINGS

The present invention will be understood more fully from the detailed description given herein below, taken in conjunction with the accompanying drawings.

In the drawings:

FIG. 1 is a schematic drawing of a prior art of crystal poling apparatus based on (a) the corona discharge method; (b) the electrostatic method with metal electrodes; (c) the electrostatic method with liquid electrodes.

FIG. 2 is a schematic diagram for explaining the concept of one configuration for broadband light generation based on a bulk nonlinear crystal according to the present invention.

FIG. 3 is a schematic diagram for explaining the first preferred embodiment of the process flow chart of crystal poling according to the present invention.

FIG. 4 is a schematic diagram for explaining the second preferred embodiment of various intra-cavity configurations for broadband light generation based on a bulk nonlinear crystal with a domain-inverted structure according to the present invention.

FIG. 5 is a schematic diagram for explaining the third preferred embodiment of various types of nonlinear crystal with an optical waveguide and a domain-inverted structure according to the present invention.

FIG. 6 is a schematic diagram for explaining the fourth preferred embodiment of various inter-cavity configurations for broadband light generation based on a nonlinear crystal with a domain-inverted structure according to the present invention.

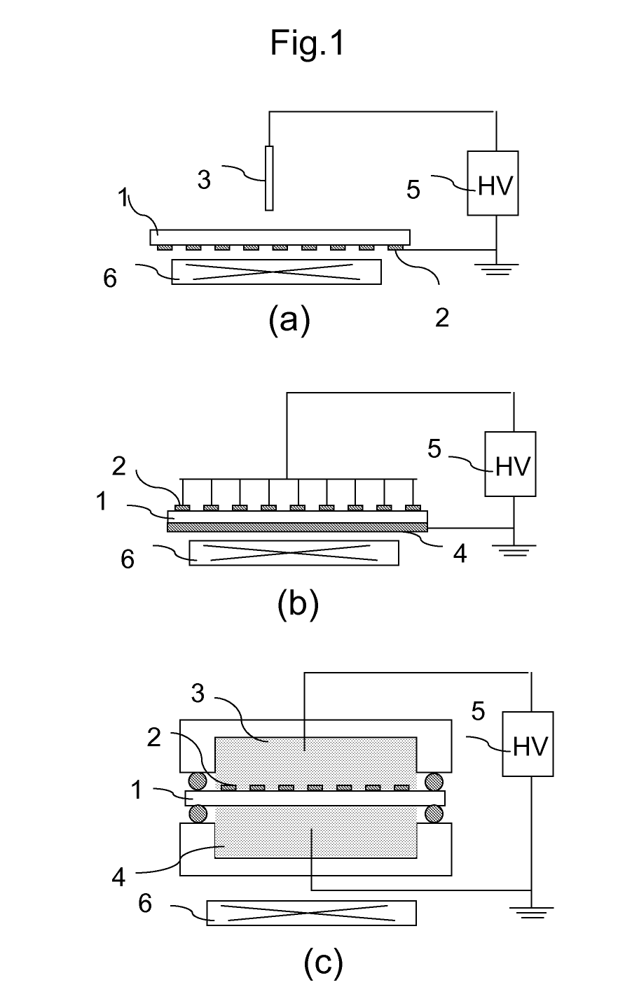

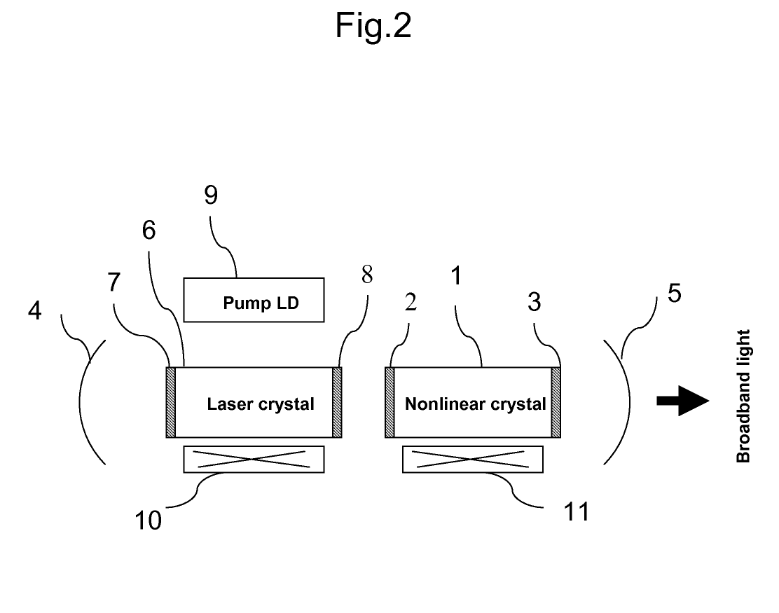

### 5. DAILED DESCRIPTION OF PREFFERED EMBODIMENTS

The present invention solves the foregoing problems by means described below.

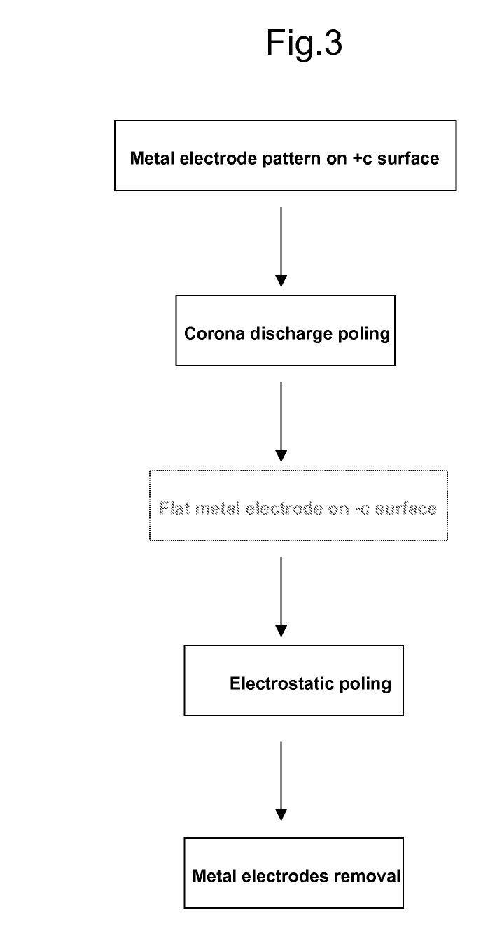

In the first preferred embodiment, as shown in FIG. 3, a preferred crystal poling process flow chart comprises electrode formation on +c surface of a ferroelectric single crystal substrate. The first poling is carried out by employing the corona discharge method to form a uniform shallow domain inversion (i.e. nucleation). After the first poling, the second poling is conducted by using the electrostatic method to form deep uniform domain inversion. Before the first poling, an electrode pattern is formed on +c surface of the ferroelectric substrate, which can be used as electrode in the second poling. Between the first poling and second poling, it may be necessary to form a layer of metal film on −c surface of the substrate if liquid electrode is not used in the second poling. After the second poling, the metal electrodes are removed by the standard etching process in an acid.

The corona discharge method used in the first poling can overcome the non-uniform doping problem since migration of the surface charges deposited by the corona discharge is very slow. As a result, crystal poling takes place as far as the local coercive field is achieved. Therefore, uniform shallow domain inversion (i.e. nucleation) can be achieved by employing the corona discharge technique. The depth of the shallow domain inversion ranges from few micrometers to hundred micrometers, which can be controlled by the voltage applied to the corona torch or wire, time of the applied high voltage, and distance between −c surface of the substrate the corona torch or wire. The typical voltage applied to the corona torch or wire can be set at a value between 1 kV and 100 kV (say 10 kV), and the time of the applied voltage can be set at a value between 10 seconds and 10 minutes (say 30 seconds).

In the second poling, since crystal poling starts from regions with a uniform domain inversion (i.e. nucleation), random nucleation process no longer occurs in the invented method. Therefore, lower electric field is required to pole the remaining of the crystal along the thickness direction and the field distribution is solely determined by the electrode pattern and is not affected by the nucleation process. As a result, uniform poling with vertical boundaries can be achieved in the second poling. The value of the applied voltage is set so that electric field achieves the coercive field of the crystal. It is worth noting that due to the random nucleation in doped crystal, which usually occurs in the conventional electrostatic poling, it is very difficult to achieve uniform poling. As a result, although the electrostatic technique is successful in poling non-doped crystals (which has no random nucleation issue), it is difficult to achieve uniform poling due to the non-uniform doping. The nucleation of the domain inversion forms randomly on the +c surface of the substrate, depending on local doping concentration. Therefore, distribution of the electric field applied across the substrate is changed when crystal poling starts and thus causes non-uniform poling.

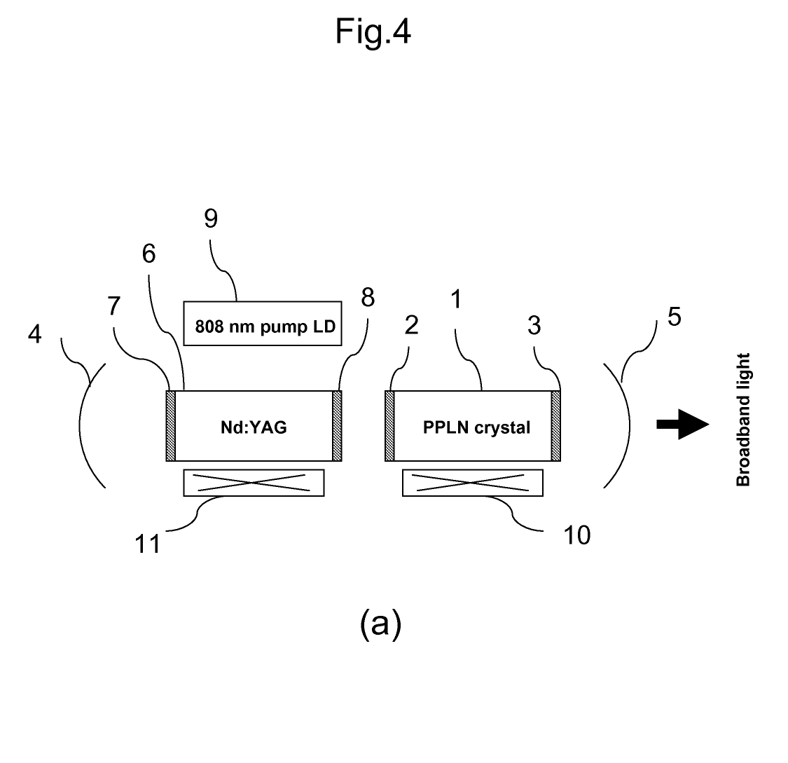

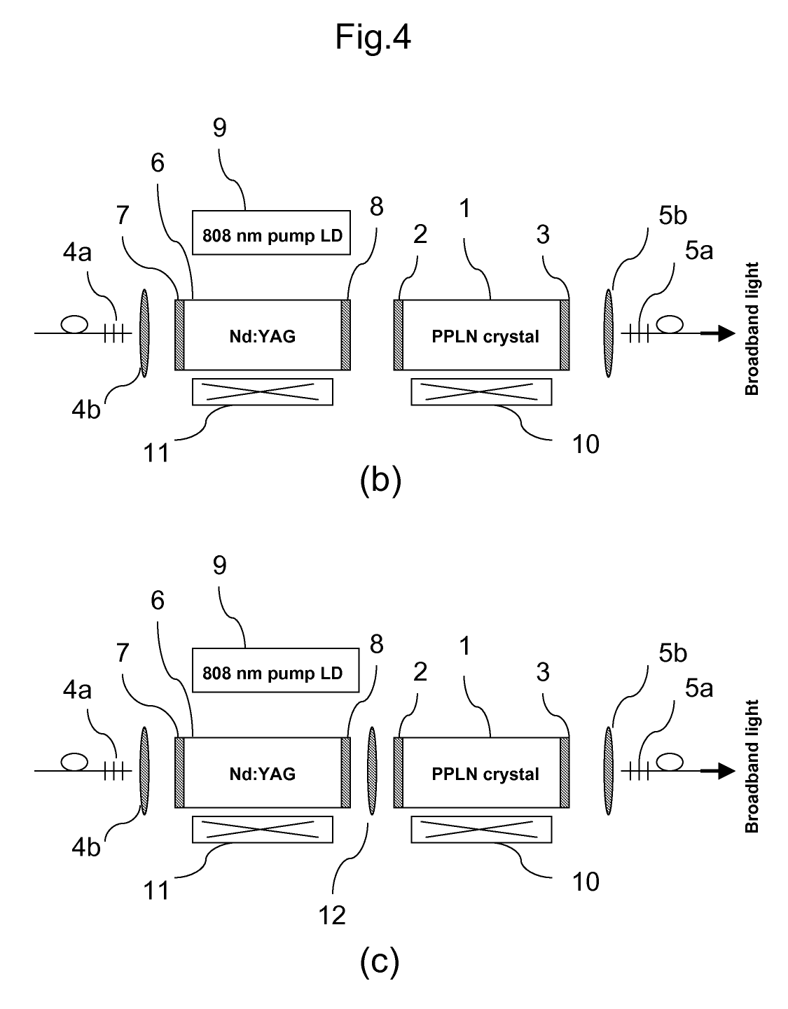

In the second preferred embodiment of the present invention, as shown in FIG. 4(a), a broadband source comprises a nonlinear crystal 1 with a domain-inverted structure (e.g. MgO doped PPLN: periodically poled lithium niobate) is placed in an optical cavity. Facets of the PPLN crystal are coated with films 2 and 3, which have high transmission around 1064 nm (with broad bandwidth) and high reflection at 532 nm. The period of the PPLN crystal is carefully designed so that the QPM condition for SHG from 1064 nm to 532 nm is satisfied, i.e. 2ω(n_{2ω}−n_{ω})=2πc/Λ, where n_{2ω} and n_{ω} are refractive indices at 2ω and ω,respectively, c is light velocity in vacuum, and Λ is the period of PPLN. The cavity is formed by a rear mirror 4 and a front mirror 5. The rear mirror has high reflectivity at around 1064 nm (with broad bandwidth), while the front mirror has high reflectivity at 1064 nm (with narrow bandwidth). A laser crystal (e.g. Nd:YAG) 6 is also put in the cavity. The facets of the laser crystal are coated with films 7 and 8, which have high transmission at 1064 nm. A pump laser diode 9 emitting high power at 808 nm is used to pump the laser crystal 6. Temperature controllers 10 and 11 may be used underneath the nonlinear crystal 1 and laser crystal 6, respectively. The cross section of the laser crystal 6 and nonlinear crystal 1 is larger than beam size of the light confined in the cavity, which is usually less than 1 mm in diameter. The length of the laser crystal and nonlinear crystal is set at a value between 1 mm and 100 mm (say 10 mm and 5 mm, respectively). The pump power of the laser diode is set at a value more than 10 mW (say 5 W).

The laser crystal 6 is pumped by the pump laser diode 9. Since the cavity mirrors 4 and 5 have high reflectivity at 1064 nm, laser oscillation occurs if the pump power of the laser diode 9 is higher than the threshold power of the designed laser. The threshold power of the laser is determined by the loss of the laser, consisting transmission loss at the cavity mirrors 4 and 5, absorption and scattering loss in the laser crystal 6 and nonlinear crystal 1, and reflection loss at the facets of the laser crystal 6 and nonlinear crystal 1. Since both the laser crystal 6 and nonlinear crystal 1 have anti-reflection (i.e. high transmission) coating at 1064 nm, the reflection loss at the crystal facets is negligibly small at 1064 nm. In addition, since high quality crystals are used, the scattering loss is also negligibly small. Furthermore, since the cut-off wavelength (i.e. a wavelength at which absorption starts becoming non-negligible) is much shorter than the wavelength discussed here (e.g. the cut-off wavelength is 340 nm in the case of MgO doped PPLN), the absorption loss in the nonlinear crystal 1 is negligible. As a result, the 1064 nm laser has characteristics such as high efficiency and high confinement of the laser light (i.e. most of laser light at 1064 nm is confined within the cavity and thus nonlinear crystal 1). As described below, these features are very helpful in achieving efficient SPDC.

As described above, intensive light at wavelength of 1064 nm is confined within the cavity and thus light intensity at 1064 nm in the PPLN nonlinear crystal 1 is very high. Since the QPM condition is satisfied in the PPLN crystal 1, 532 nm is generated efficiently due to the SHG process. In addition, since high reflection coating is employed at the two facets 2, 3 of the PPLN crystal 1, the generated SHG light at 532 nm is strongly confined within the PPLN crystal 1. The light intensity of 532 nm light can be maximized by choosing proper length of the PPLN crystal 1 and/or tuning of the temperature of the PPLN crystal by the temperature controller 10 beneath the PPLN crystal 1 so that the roundtrip phase in the PPLN crystal at 532 nm is an integer time of 2π.

Due to the existence of the intensive 532 nm light in the PPLN crystal 1, a signal and an idle light at angular frequency ωₛ and ωᵢ, respectively, are generated around 1064 nm (where ω₅₃₂₋ₙₘ=ωₛ+ωᵢ) through the spontaneous parametric down conversion (SPDC) process. In the SPDC process, the QPM condition has to be satisfied, i.e. ω₅₃₂₋ₙₘ n₅₃₂₋ₙₘ31 ωₛnₛ−ωᵢnᵢ=2πc/Λ, where nₛ and nᵢ are refractive indices at ωₛ and ωᵢ respectively, c is light velocity in vacuum, and Λ is the period of PPLN crystal. Since many pairs of ωₛ and ωᵢ. can satisfy the QPM condition for a fixed period, the generated SPDC light has a broad bandwidth. It is worth noting that use of MgO doped PPLN crystal is very important to achieve high power, broadband source. Since the QPM condition can be satisfied over a broad range of ωₛ and ωᵢ, which is especially true if a short PPLN crystal and/or chirped PPLN crystal is employed, very broadband light can be generated. In addition, since MgO doped PPLN is used, which has very high optical damage threshold, 532 nm light with very high intensity can be confined within the PPLN crystal, and thus broadband light with high power can be generated. Different from the conventional SPDC reported in the literatures, the pump light of the SPDC, i.e. 532 nm light, is strongly confined within the PPLN crystal, and thus the SPDC light with broad bandwidth is generated with high efficiency since the SPDC efficiency is proportional to the pump power. In addition, the generated SPDC light propagating towards the rear cavity mirror 4 is reflected back since the mirror has high reflectivity over a broad bandwidth at around 1064 nm, which further enhances the output power of the SPDC light. Since the front cavity mirror 5 has a narrow band reflection only at 1064 nm, the generated SPDC light experiences little reflection loss at the front cavity mirror 5. Further, if the 532 nm light is strong enough, the generated SPDC light may be further enhanced due to the parametric amplification process when the SPDC light passes through the PPLN crystal 1.

In the third preferred embodiment of the present invention, an alternative configuration of broadband source is presented, as shown in FIG. 4(b). The rear cavity mirror 4 described in FIG. 4(a) are replaced by a broad bandwidth fiber Bragg grating 4a and a lens 4b, while the front cavity mirror 5 described in FIG. 3(a) are replaced by a narrow bandwidth fiber Bragg grating 5a and a lens 5b. The bandwidth of the fiber Bragg grating 4a can be set at value as large as 100 nm, while the bandwidth of the fiber Bragg grating 5a can be set at value as small as 0.1 nm. The characteristic of the present invention is that the generated broadband light can have fiber output. If a narrow fiber Bragg grating is also used in the rear cavity mirror, the broadband light can be accessed from both output ports.

In the fourth preferred embodiment of the present invention, as shown in FIG. 4(c), additional lens 12 is used between the laser crystal 6 and the nonlinear crystal 1. As compared with the configuration described in FIG. 4(b), a longer nonlinear crystal can be used while a small beam diameter is maintained in the cavity. Since the SPDC efficiency is proportional to the square of the nonlinear crystal length, using of a longer nonlinear crystal results a higher SPDC efficiency.

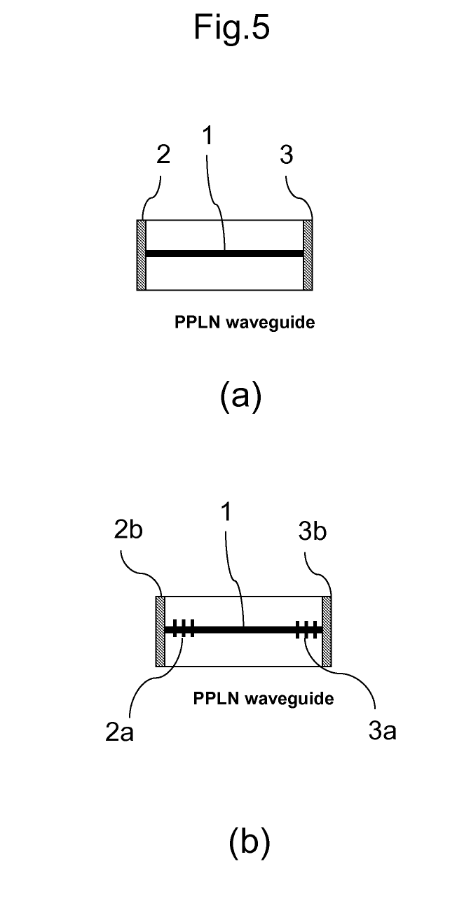

In the fifth preferred embodiment of the present invention, as shown in FIG. 5(a), a waveguide type nonlinear crystal is used in SPDC process. Using waveguide 1 results enhancement of light intensity significantly and enables the use of long device. As a result, the SPDC efficiency can be enhanced. Similar to the description in FIG. 4(a), facets of the PPLN waveguide are coated with films 2 and 3, which have high transmission around 1064 nm (with broad bandwidth) and high reflection at 532 nm. The period of the PPLN crystal is carefully designed so that the QPM condition for SHG from 1064 nm to 532 nm is satisfied, i.e. 2ω(n_{2ω}−n_{ω})=2πc/Λ, where n_{2ω} and n_{ω} are effective refractive indices at 2ω and ω, respectively, c is light velocity in vacuum, and Λ is the period of PPLN.

In the sixth preferred embodiment of the present invention, as shown in FIG. 5(b), integrated Bragg gratings 2a and 3a are formed at each end of the waveguide 1, respectively. High transmission (i.e. anti-reflection) coating 2b, 3b at wavelength of 1064 nm is applied on the two facets of the waveguide. As compared with the configuration shown in FIG. 5(a), the coating at the two facets of the waveguide is much easier, which reduces production cost of the nonlinear crystal. The period of the PPLN waveguide is carefully designed so that the QPM condition for SHG from 1064 nm to 532 nm is satisfied, i.e. 2ω(n_{2ω}−n_{ω})=2πc/Λ, where n_{2ω} and n_{ω} are effective refractive indices at 2ω and ω, respectively, c is light velocity in vacuum, and Λ is the period of PPLN.

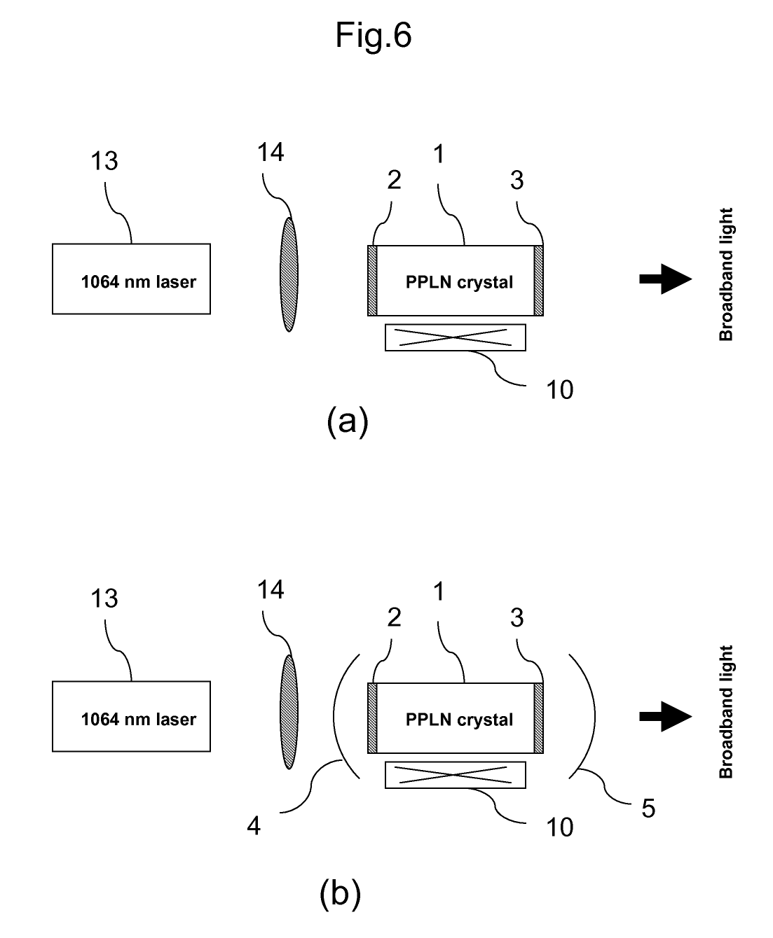

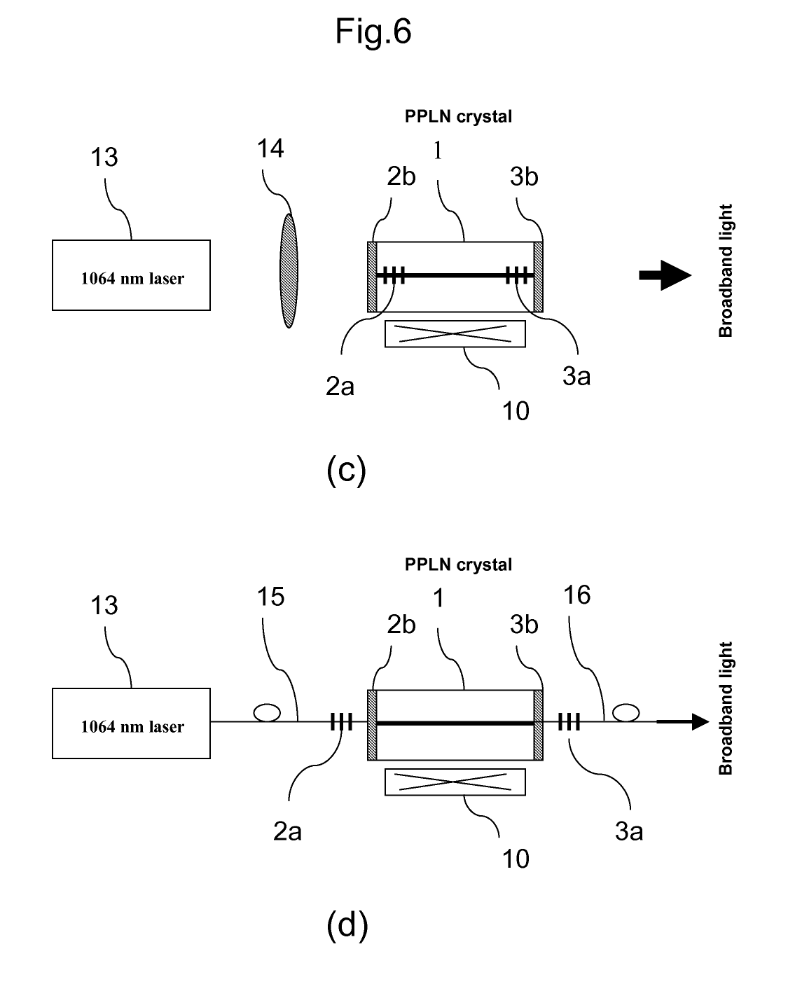

In the seventh preferred embodiment of the present invention, as shown in FIG. 6(a), 1064 nm laser 13 is separated from the nonlinear crystal 1. The 1064 nm light passes the nonlinear crystal 1 for only one time, while the generated SHG light at 532 nm is confined within the crystal. The 532 nm light acts as a pump light in the following SPDC process. The facets of the PPLN crystal are coated with films 2 and 3. Film 2 has high transmission at 1064 nm (with narrow bandwidth), high reflection at 532 nm and high reflection around 1064 nm (with broad bandwidth), while film 3 has high transmission around 1064 nm (with broad bandwidth) and high reflection at 532 nm. 1064 nm light is coupled into crystal by a lens 14. The period of the PPLN crystal is carefully designed so that the QPM condition for SHG from 1064 nm to 532 nm is satisfied, i.e. 2ω(n_{2ω}−n_{ω})=2πc/Λ, where n_{2ω} and n_{ω} are refractive indices at 2ω and ω, respectively, c is light velocity in vacuum, and Λ is the period of PPLN. Similar to FIG. 3(a), a temperature controller 10 may be used underneath the nonlinear crystal 1. The cross section of the nonlinear crystal 1 is larger than beam size of the light confined in the cavity, which is usually less than 1 mm in diameter. The length of the nonlinear crystal is set at a value between 1 mm and 100 mm (say 5 mm).

In the eighth preferred embodiment of the present invention, as shown in FIG. 6(b), 1064 nm laser 13 is separated from the nonlinear crystal 1. The 1064 nm light passes the nonlinear crystal for only one time, while the generated. SHG light at 532 nm is confined within the crystal by a pair of cavity mirrors 4, 5. The 532 nm light acts as a pump light in the following SPDC process. The facets of the PPLN crystal are coated with films 2 and 3. Film 2 has high transmission at 1064 nm (with narrow bandwidth) and high reflection around 1064 nm (with broad bandwidth), while film 3 has high transmission around 1064 nm (with broad bandwidth). 1064 nm light is coupled into cavity by a lens 14. The period of the PPLN crystal is carefully designed so that the QPM condition for SHG from 1064 nm to 532 nm is satisfied, i.e. 2ω(n_{2ω}−n_{ω})=2πc/Λ, where n_{2ω} and n_{ω} are refractive indices at 2ω and ω, respectively, c is light velocity in vacuum, and Λ is the period of PPLN. Similar to FIG. 3(a), a temperature controller 10 may be used underneath the nonlinear crystal 1.

In the ninth preferred embodiment of the present invention, as shown in FIG. 6(c), 1064 nm laser 13 is separated from a waveguide type nonlinear crystal 1. The 1064 nm light passes the nonlinear waveguide for only one time, while the generated SHG light at 532 nm is confuted within the crystal by a pair of integrated Bragg grating 2a, 3a. The 532 nm light acts as a pump light in the following SPDC process. The facets of the PPLN waveguide are coated with films 2b and 3b. Film 2b has high transmission at 1064 nm (with narrow bandwidth) and high reflection around 1064 nm (with broad bandwidth), while film 3b has high transmission around 1064 nm (with broad bandwidth). 1064 nm light is coupled into waveguide by a lens 14. The period of the PPLN waveguide is carefully designed so that the QPM condition for SHG from 1064 nm to 532 nm is satisfied, i.e. 2ω(n_{2ω}−n_{ω})=2πc/Λ, where n_{2ω} and n_{ω} are effective refractive indices at 2ω and ω, respectively, c is light velocity in vacuum, and Λ is the period of PPLN. Similar to FIG. 3(a), a temperature controller 10 may be used underneath the nonlinear crystal 1.

In the tenth preferred embodiment of the present invention, as shown in FIG. 6(d), 1064 nm laser 13 is separated from a waveguide type nonlinear crystal 1. The 1064 nm light passes the nonlinear waveguide for only one time, while the generated SHG light at 532 nm is confuted within the crystal by a pair of fiber Bragg grating 2a, 3a. The 532 nm light acts as a pump light in the following SPDC process. The facets of the PPLN waveguide are coated with films 2b and 3b. Film 2b has high transmission at 1064 nm (with narrow bandwidth) and high reflection around 1064 nm (with broad bandwidth), while film 3b has high transmission around 1064 nm (with broad bandwidth). 1064 nm light is coupled into waveguide by directly coupling between single mode fibers 15, 16 and waveguide. The period of the PPLN waveguide is carefully designed so that the QPM condition for SHG from 1064 nm to 532 nm is satisfied, i.e. 2ω(n_{2ω}−n_{ω})=2πc/Λ, where n_{2ω} and n_{ω} are effective refractive indices at 2ω and ω, respectively, c is light velocity in vacuum, and Λ is the period of PPLN. Similar to FIG. 3(a), a temperature controller 10 may be used underneath the nonlinear crystal 1.

The above embodiments have described crystal poling of MgO doped lithium niobate. Of course, the methods described in the present invention can be applied to other ferroelectric materials such as LiTaO₃, KTP, etc.

The above embodiments have included a metal electrode in crystal poling. Of course, liquid electrode and/or different combinations of the metal and liquid electrode can also achieve uniform crystal poling. These configurations can be combined in different ways with those explicitly described in the present patent.

The above embodiments have described the broadband light generation around 1064 nm. Of course, broadband sources centered at other wavelength such as 1310 nm can also be generated by the similar configures.

The above embodiments have described the heating unit attached with the crystals. Of course, other heating unit such as IR heater can also provide the similar effect of increasing the temperature of the crystals.

What is claimed is:

1. A method for ferroelectric domain inversion comprising a first poling step and a second poling step by employing a single electrode pattern, wherein the first step is to create uniform nucleation of domain inversion underneath electrode pattern, while the second step is to form a deep uniform domain inversion through the thickness of substrate in the regions with initial nucleation.

2. The first poling of claim 1, wherein a corona discharge crystal poling method is used to create nucleation of domain inversion in the regions underneath electrodes.

3. The second poling of claim 1, wherein an electrostatic poling method is used to form a deep uniform domain inversion throughout the thickness of the ferroelectric substrate in the regions with initial nucleation.

4. The electrode pattern of claim 2, wherein further characterized by being
formed by metal on +c surface of a ferroelectric substrate, and
grounded.

5. The electrostatic poling method of claim 3, wherein a metal electrode with an area similar to the size of the electrode pattern on +c surface is formed on −c surface of the ferroelectric substrate and used as the second electrode in the electrostatic poling.

6. The electrostatic poling method of claim 3, wherein a liquid electrode with an area similar to the size of the electrode pattern on +c surface is formed on −c surface of the ferroelectric substrate and used as the second electrode in the electrostatic poling.

7. A broadband source apparatus, comprising:
a laser crystal to generate fundamental light at a wavelength λ_{f} required in the following second harmonic generation process; and
an optical nonlinear crystal to generate second harmonic light a wavelength λ_{f}/2; and
a pump diode laser a wavelength λₚ; and
a first optical cavity to confine the light at wavelength λ_{f} within the cavity containing the laser crystal and nonlinear crystal; and
a second optical cavity to confine the light at wavelength of λ_{f}/2 within the nonlinear crystal; and
a first temperature controller underneath the laser crystal to control the temperature of the laser crystal; and
a second temperature controller underneath the nonlinear crystal to control the temperature of the nonlinear crystal and maximize light intensity at wavelength of λ_{f}/2 within the nonlinear crystal.

8. The first optical cavity of claim 7, wherein further comprising
a curved mirror as a rear mirror of the cavity with high reflectivity at wavelength around λ_{f} (broad band); and
a curved mirror as a front mirror of the cavity with sharp high reflectivity at wavelength λ_{f} (narrow band).

9. The laser crystal of claim 7, wherein further comprising
two facets with high transmission coating (or anti-reflection coating) at wavelength around λ_{f} (broad band); and
a cross section larger than the beam diameter of the light confined in the cavity.

10. The nonlinear crystal of claim 7, wherein further comprising
Periodically domain inverted structure with a period satisfying the quasiphase matching condition to generate second harmonic light at half wavelength of λ_{f} from fundamental light of wavelength λ_{f}; and
two facets with high transmission coating (or anti-reflection coating) at wavelength around (broad band), and high reflection at half wavelength of λ_{f} to form the second cavity; and
a cross section larger than the beam diameter of the light confined in the first cavity.

11. The first optical cavity of claim 7, wherein further comprising
a first fiber Bragg grating as a rear mirror of the cavity with high reflectivity at wavelength around λ_{f} (broad band); and
a second fiber Bragg grating as a front mirror of the cavity with sharp high reflectivity at wavelength λ_{f} (narrow band);

12. The means to couple light beam of claim 11, wherein further comprising
a first lens to couple light from the first fiber Bragg grating into the laser crystal; and
a second lens to couple light into the nonlinear crystal; and
a third lens to couple light from the nonlinear crystal into the second fiber Bragg grating.

13. The nonlinear crystal of claim 7, wherein further comprising
A periodically domain inverted waveguide with a period satisfying the quasiphase matching condition to generate SH light at half wavelength of λ_{f} from fundamental light at wavelength of λ_{f}; and
two facets with high transmission coating (or anti-reflection coating) at wavelength around λ_{f} (broad band), and high reflection at half wavelength of λ_{f} to form the second cavity.

14. The nonlinear crystal of claim 7, wherein further comprising
A periodically domain inverted waveguide with a period satisfying the quasiphase matching condition to generate SH light at half wavelength of λ_{f} from fundamental light at wavelength of λ_{f}; and
an integrated Bragg grating with high reflection at half wavelength of λ_{f} to form the second cavity; and
two facets with high transmission coating (or anti-reflection coating) at wavelength around λ_{f} (broad band).

15. A broad band source apparatus, wherein further comprising:
a pump laser emitting at a wavelength λ_{f} required in the following second harmonic generation process; and
an optical nonlinear crystal to generate second harmonic light a wavelength λ_{f}/2; and
an optical cavity to confine the light at half wavelength λ_{f} within the cavity; and
a rear mirror of said optical cavity that highly reflects light around wavelength λ_{f} and at wavelength λ_{f}/2, but highly transmit light at wavelength λ_{f}; and
a front mirror of said optical cavity that highly reflects light at wavelength λ_{f}/2, but highly transmit light around wavelength λ_{f}; and
a lens to couple light at wavelength of into the cavity; and
a temperature controller underneath the nonlinear crystal.

16. The optical cavity and nonlinear crystal of claim 15, wherein further comprising
The optical cavity is formed by a pair of curved mirrors, a rear curved mirror of said optical cavity highly reflects light around wavelength λ_{f} and at wavelength λ_{f}/2, but highly transmit light at wavelength λ_{f}; while a front curved mirror of said optical cavity highly reflects light at wavelength λ_{f}/2, but highly transmit light around wavelength λ_{f}; and
The nonlinear crystal has periodically domain inverted structure with a period satisfying the quasiphase matching condition to generate SH light at wavelength of half of λ_{f} from fundamental light at wavelength of λ_{f}; and
two facets of the nonlinear crystal have high transmission coating (or anti-reflection coating) at wavelength around λ_{f} (broad band); and
cross section of the nonlinear crystal is larger than the beam diameter of the light confined in the cavity.

17. The optical cavity and the nonlinear crystal of claim 15, wherein further comprising
periodically domain inverted nonlinear crystal with two facets to form the cavity, a rear facet coating highly reflects light around wavelength λ_{f} and at wavelength λ_{f}/2, but highly transmit light at wavelength λ_{f}; while a front facet coating highly reflects light at wavelength λ_{f}/2, but highly transmit light around wavelength λ_{f}; and
periodically domain inverted structure of the nonlinear crystal satisfies the quasiphase matching condition to generate SH light at half wavelength of Ac from fundamental light at wavelength of λ_{f}; and
cross section of the nonlinear crystal is larger than the beam diameter of the light confined in the crystal.

18. The nonlinear crystal of claim 15, wherein further comprising
an optical waveguide; and
periodically domain inverted structure with a period satisfying the quasiphase matching condition to generate SH light at wavelength of half of λ_{f} from fundamental light at wavelength of λ_{f}; and
two integrated Bragg gratings at each end of the waveguide reflecting light at half wavelength of λ_{f} to form the cavity; and
two facets with high transmission coating, a rear facet coating highly reflects light around wavelength λ_{f}, but highly transmit light at wavelength λ_{f}; while a front facet coating highly transmit light around wavelength λ_{f}.

19. The optical cavity of claim 15, wherein further comprising
two fiber Bragg gratings as cavity mirrors with high reflectivity at half wavelength of λ_{f}; and
a nonlinear waveguide with a periodically domain inverted structure. The period of the nonlinear waveguide satisfies the quasiphase matching condition to generate SH light at wavelength of half of λ_{f} from fundamental light at wavelength of λ_{f}; and
two facets with high transmission coating, a rear facet coating highly reflects light around wavelength λ_{f}, but highly transmit light at wavelength λ_{f}; while a front facet coating highly transmit light around wavelength λ_{f}.
